(19) United States
(12) Patent Application Publication
(10) Pub. No.: US 2026/0077475 A1
(43) Pub. Date: Mar. 19, 2026

(54) MULTIFUNCTION TOOL WITH INTEGRATED CARRY CASE AND MAGNETIZED PARTS TRAY

(71) Applicant: Multitasker Tools LLC, Atlanta, GA (US)

(72) Inventor: Shane Keng, Marietta, GA (US)

(21) Appl. No.: 19/332,866

(22) Filed: Sep. 18, 2025

Related U.S. Application Data
(60) Provisional application No. 63/695,920, filed on Sep. 18, 2024.

(51) Int. Cl. B25H 3/00

(52) U.S. Cl. CPC B25H 3/006; B25H 3/003

(57) ABSTRACT

Tool storage boxes and related methods are provided. In one example, a tool storage box may include a base, one or more metal tool parts, and a magnetized plate. The base may define a first cavity disposed along an internal surface of the base and a second cavity disposed along an external surface of the base. The one or more metal tool parts may be removably disposed within the first cavity. The magnetized plate may be disposed within the second cavity and configured for releasably retaining the one or more metal tool parts along the external surface of the base when the one or more metal tool parts are placed thereon.

### CROSS-REFERENCE TO RELATED APPLICATIONS

This application claims the benefit of U.S. Provisional Application No. 63/695,920, filed on Sep. 18, 2024, the entire contents of which are incorporated by reference herein.

### FIELD OF THE DISCLOSURE

The present disclosure relates generally to tools and, more particularly, to multifunction tools having an integrated carry case and a magnetized parts tray and related methods of manufacturing and using the same.

### BACKGROUND OF THE DISCLOSURE

To facilitate proper functioning of firearms and their ancillary accessories, it generally may be necessary to have multiple tools in order to perform key maintenance tasks, such as disassembly, cleaning, and installation/removal of accessory mounts, or to ensure that such accessories are properly secured.

Carrying and storing these various tools and their interchangeable screwdriver bits for subsequent use generally may require one or more separate boxes or nylon pouches. When disassembling a firearm, proper disassembly procedure may require the removal of multiple components, including receiver pins, an extractor, an extractor spring, a firing pin, a firing pin spring, and/or other components. Additionally, more advanced firearms, such as those issued to the military, may be provided with multiple optical sights, laser designators, and related switches coupled by various fasteners which require dedicated screwdrivers to adjust, install, or remove these components. Such tool parts typically may be quite small and thus easy to lose. Although dedicated plastic or metal trays may be used for corralling such loose parts during the disassembly process, these products are not integrated into the storage box/case and thus may present challenges in organizing and keeping track of the parts as well as the trays.

A need, therefore, exists for an improved storage box with a parts tray and methods for manufacturing and using the same, which may overcome one or more of the above-mentioned drawbacks associated with existing storage boxes and parts trays.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is an exploded perspective view of a tool storage box in accordance with one or more examples of the disclosure, showing a base, a lid, a storage tube, a nut, a plurality of tool parts, a bit holder, and a set of driver bits.

FIG. 2 is another exploded perspective view of the tool storage box of FIG. 1.

FIG. 3 is an exploded front view of the tool storage box of FIG. 1.

FIG. 4 is a rear view of the tool storage box of FIG. 1, with the base and the storage tube shown in transparent view for visualization of the other components disposed therein.

### DETAILED DESCRIPTION OF THE DISCLOSURE

The present disclosure is directed to storage tool boxes with a magnetic parts tray and related methods for manufacturing and using the same.

As discussed above, to facilitate proper functioning of firearms and their ancillary accessories, it generally may be necessary to have multiple tools in order to perform key maintenance tasks, such as disassembly, cleaning, and installation/removal of accessory mounts, or to ensure that such accessories are properly secured. For carrying and storing these various tools and their interchangeable screwdriver bits for subsequent use, one or more separate boxes or nylon pouches may be used. In various instances, when disassembling a firearm, proper disassembly procedure may require the removal of multiple components, including receiver pins, an extractor, an extractor spring, a firing pin, a firing pin spring, and/or other components. Additionally, when working with more advanced firearms, such as those issued to the military, the firearm may be provided with multiple optical sights, laser designators, and related switches coupled by various fasteners which require dedicated screwdrivers to adjust, install, or remove these components. Such tool parts typically may be quite small and thus easy to lose. Although dedicated plastic or metal trays may be used for corralling such loose parts during the disassembly process, these products are not integrated into the storage box/case and thus may present challenges in organizing and keeping track of the parts as well as the trays.

The present disclosure provides a compact, self-contained tool storage box that may function as the tool kit itself and may include an integral magnetized parts tray to hold metal tool parts as well as loose disassembled metal components.

In one aspect, a tool storage box is provided. The tool storage box may include a base, one or more metal tool parts, and a magnetized plate. The base may define a first cavity disposed along an internal surface of the base and a second cavity disposed along an external surface of the base. The one or more metal tool parts may be removably disposed within the first cavity. The magnetized plate may be disposed within the second cavity and configured for releasably retaining the one or more metal tool parts along the external surface of the base when the one or more metal tool parts are placed thereon.

In some examples, the one or more metal tool parts may include one or more driver bits. In some examples, the one or more metal tool parts may include one or more pin punches. In some examples, the tool storage box also may include a lid removably coupled to the base and covering an open end of the base. In some examples, the lid may be removably coupled to the base by a plurality of tabs and a plurality of cutouts having an interference fit. In some examples, the tool storage box also may include a storage tube coupled to the lid and defining an internal cavity, and one or more tool parts disposed within the internal cavity of the storage tube. In some examples, the storage tube may be removably coupled to the lid by a nut. In some examples, the storage tube may be configured for use as a driver when coupled to the lid by the nut, and the lid may be configured for use as a handle when coupled to the storage tube by the nut. In some examples, the one or more tool parts may include one or more one or more pin punches. In some examples, the base also may define a third cavity disposed along the internal surface of the base and configured for removably receiving the storage tube therein when the lid is coupled to the base.

In another aspect, a tool storage box is provided. The tool storage box may include a base, a lid, a storage tube, and one or more tool parts. The base may define a first cavity disposed along an internal surface of the base. The lid may be removably coupled to the base and covering an open end of the base. The storage tube may be coupled to the lid and define an internal cavity, and the storage tube may be removably disposed within the first cavity when the lid is coupled to the base. The one or more tool parts may be disposed within the internal cavity of the storage tube.

In some examples, the storage tube may be removably coupled to the lid by a nut. In some examples, the storage tube may be configured for use as a driver when coupled to the lid by the nut, and the lid may be configured for use as a handle when coupled to the storage tube by the nut. In some examples, the one or more tool parts may include one or more one or more pin punches. In some examples, the lid may be removably coupled to the base by a plurality of tabs and a plurality of cutouts having an interference fit. In some examples, the base also may define a second cavity disposed along the internal surface of the base and configured for receiving one or more additional tool parts. In some examples, the one or more additional tool parts may include one or more driver bits. In some examples, the one or more driver bits may include a plurality of driver bits coupled to a bit holder. In some examples, the base also may define a third cavity disposed along an external surface of the base and retaining a magnetized plate therein, and the magnetized plate may be configured for releasably retaining one or more metal tool parts along the external surface of the base when the one or more metal tool parts are placed thereon.

In another aspect, a tool storage box is provided. The tool storage box may include a base, a lid, a storage tube, one or more tool parts, one or more metal tool parts, and a magnetized plate. The base may define a first cavity disposed along an internal surface of the base, a second cavity disposed along the internal surface of the base, and a third cavity disposed along an external surface of the base. The lid may be removably coupled to the base and covering an open end of the base. The storage tube may be coupled to the lid and defining an internal cavity, and the storage tube may be removably disposed within the first cavity when the lid is coupled to the base. The one or more tool parts may be disposed within the internal cavity of the storage tube. The one or more metal tool parts may be removably disposed within the second cavity. The magnetized plate may be disposed within the third cavity and configured for releasably retaining the one or more metal tool parts along the external surface of the base when the one or more metal tool parts are placed thereon.

Further benefits and advantages of the disclosed tool storage boxes and related methods of manufacturing and using the same will be appreciated by one skilled in the art upon review of the following description in conjunction with the appended drawings.

### Example Tool Storage Boxes

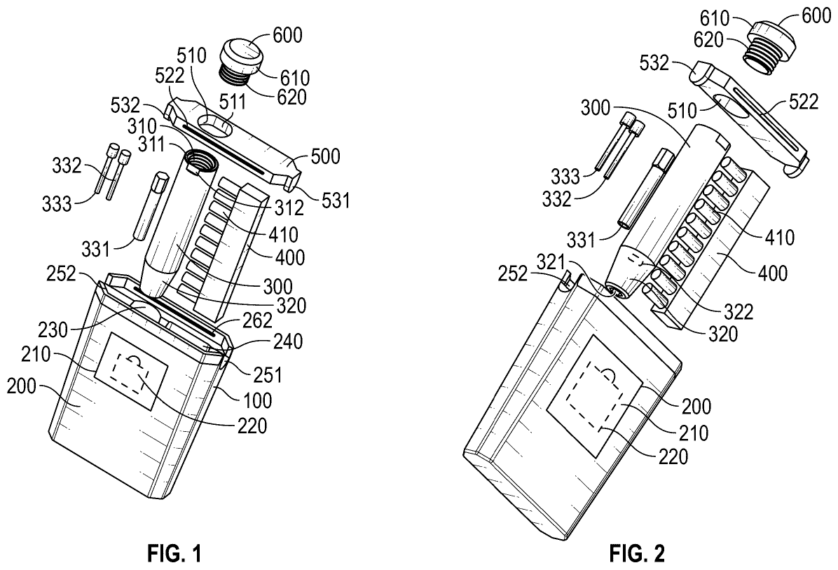

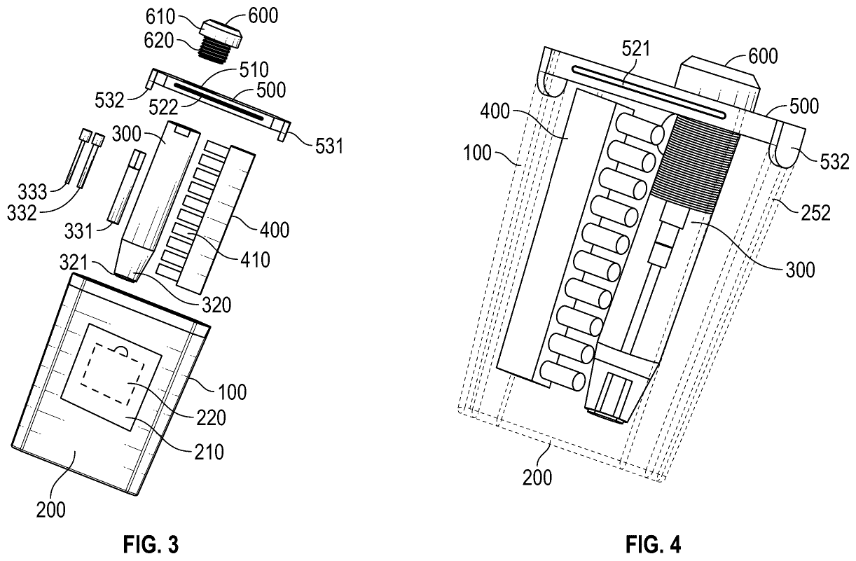

Referring now to the drawings, FIGS. 1-4 illustrate a storage box 100 (which also may be referred to as a “tool storage box,” a “tool box,” or a “tool case”) and components thereof in accordance with one or more examples of the disclosure. The storage box 100 may include various types of tool parts and components, which may be configured for installing, removing, and/or adjusting various types of components. In some instances, the tool parts and components of the storage box 100 may be particularly configured for use with firearms, with particular tool parts being configured for installing, removing, and/or adjusting different components of a firearm, for example, for disassembling and reassembling the firearm. As described herein, certain portions of the storage box 100 may be used not only as a means for storing tool parts but also as tools themselves, which may be used in cooperation with one or more of the stored too parts. Additionally, as described, certain portions of the storage box 100 may be configured for containing tool parts when the storage box 100 is assembled and not in use, while other portions of the storage box 100 may be configured for temporarily retaining tool parts when the storage box 100 is at least partially disassembled and in use, thereby enhancing organization of the tool parts and inhibiting misplacement of such tool parts. As shown, the storage box 100 may be formed as an elongate structure having a top end and a bottom end disposed opposite one another along a vertical, longitudinal axis of the storage box 100, a front side and a rear side disposed opposite one another, and a pair of lateral sides disposed opposite one another. It will be appreciated that the illustrated shape and configuration of the storage box 100 is merely one example, and that the storage box 100 may have various different shapes in other examples.

As shown, the storage box 100 may include a base 200 (which also may be referred to as a “base portion,” a “base section,” a “bottom portion,” a “bottom section,” an “outer case,” or a “case”), a storage tube 300 (which also may be referred to as a “central storage tube,” a “tool storage tube,” a “tube,” a “tool driver,” or a “driver”), a bit holder 400 (which also may be referred to as a “driver bit holder,” a “hex bit holder,” a “screwdriver bit holder,” a “magnetic bit holder,” a “bit strip,” a “molded bit strip,” or a “molded strip”), a lid 500 (which also may be referred to as a “lid portion,” a “lid section,” a “removable lid,” a “top portion,” a “top section,” a “driver handle,” a “handle,” a “driver grip,” or a “grip”), and a nut 600 (which may also be referred to as a “locking nut,” a “locking fastener,” a “fastener,” a “driver nut,” or a “driver fastener”). It will be appreciated that the illustrated shapes and configurations of the base 200, the storage tube 300, the bit holder 400, the lid 500, and the nut 600 are merely respective examples, and that these components may have various different shapes in other examples.

The base 200 may be formed as an elongate structure having a top end and a bottom end disposed opposite one another along a vertical, longitudinal axis of the base 200, a front side and a rear side disposed opposite one another, and a pair of lateral sides disposed opposite one another. As shown, the top end of the base 200 may be open, while the bottom end, the front side, the rear side, and the lateral sides may be closed. In this manner, the base 200 may define an internal space for removably containing the storage tube 300, the bit holder 400, and other tool parts of the storage box 100. As shown, the base 200 may define a plurality of cavities for receiving tool parts and/or other components of the storage box 100. In particular, the base 200 may define a first cavity 210 (which also may be referred to as a “first molded cavity” or a “magnetized plate cavity”), a second cavity 230 (which also may be referred to as a “second molded cavity” or a “storage tube cavity”), and a third cavity 240 (which also may be referred to as a “third molded cavity” or a “driver bit cavity”). The first cavity 210 may receive a magnetized plate 220 therein. In some examples, as shown, the first cavity 210 may be disposed on the exterior of the base 200, along the front side thereof, and the magnetized plate 220 may be embedded underneath. Other positions and arrangements of the first cavity 210 and the magnetized plate 220 may be used in other examples. The positioning of the magnetized plate 220 may provide a magnetic parts tray of the base 200, which may be used for temporarily retaining metal tool parts thereon, for example, when the storage box 100 is being used, such that the retained tool parts are available for quick use while minimizing the likelihood that the tool parts will be misplaced. As shown, the second cavity 230 may be configured for removably receiving the storage tube 300 when the storage box 100 is assembled and not in use. In this manner, the second cavity 230 may be sized and shaped to receive at least a portion of the storage tube 300 therein. As shown, the third cavity 240 may be configured for removably receiving the bit holder 400 and a set of driver bits 410 coupled to the bit holder 400 therein. In this manner, the third cavity 240 may be sized and shaped to receive at least a portion of the bit holder 400 and the driver bits 410 therein.

As shown, the base 200 also may include a plurality of cutouts configured for cooperating with mating features of the lid 500, facilitating a detachable connection between the lid 500 and the base 200. In particular, the base 200 may include a pair of first cutouts 251, 252 (which also may be referred to as “notched cutouts” or “external cutouts”) and a pair of second cutouts 261, 262 (which also may be referred to as “horizontal cutouts” of “internal cutouts”). As shown, the first cutouts 251, 252 may be disposed along the top end of the base 200 and defined in and through the lateral walls thereof, although other positions of the first cutouts 251, 252 may be used in other examples. The first cutouts 251, 252 may be configured to removably receive mating first tabs 531, 532 of the lid 500, respectively. As shown, the second cutouts 261, 262 may be disposed near the top end of the base 200 and defined in the internal side of the front wall and the rear wall thereof, although other positions of the second cutouts 261, 262 may be used in other examples. The second cutouts 261, 262 may be configured to removably receive mating second tabs 521, 522 of the lid 500, respectively. The mating connections between the first cutouts 251, 252 and the first tabs 531, 532 and between the second cutouts 251, 262 and the second tabs 521, 522 each may provide a secure interference-fit connection, such as a snap-fit connection, for removably attaching the lid 500 to the base 200.

The storage tube 300 may be formed as an elongate, tubular member having a top end and a bottom end disposed opposite one another along a vertical, longitudinal axis of the storage tube 300, with a lateral wall extending around the longitudinal axis. In some examples, as shown, the storage tube 300 may have a cylindrical shape, with a circular cross-sectional shape, although other shapes of the storage tube 300 may be used in other examples. The storage tube 300 may define an internal cavity 310 therein configured for removably receiving and storing one or more tool parts. For example, the internal cavity 310 may be configured for storing a Glock front sight installation tool 331, a 3/32″ receiver pin punch 332, and a 1/16″ receiver pin punch 333, although other types of tools may be provided and stored within the internal cavity 310 in other examples. As shown, the storage tube 300 may include threads 311 disposed about the top end of the storage tube 300 and configured for coupling with mating threads 620 of the nut 600. In some examples, as shown the threads 311 of the storage tube 300 may be internal threads, and the threads 620 of the nut 600 may be external threads, although an opposite arrangement of external and internal threads may be used in other examples. As shown, the storage tube 300 may include a pair of flat notches 312 disposed on opposite sides thereof and configured for engaging mating, squared-off cutouts 511, 512 defined along a central cavity 510 of the lid 500. The engagement between the notches 312 and the cutouts 511, 512 may prevent unwanted rotation of the storage tube 300 relative to the lid 500 when the storage tube 300 is coupled to the lid 500 by the nut 600. Preventing such rotation may be beneficial when the storage tube 300 and the lid 500 are coupled to one another by the nut 600 and used as a driver with one of the driver bits 410 or as a striking tool with one of the pin punches 332, 333. As shown, the storage tube 300 may have a tapered end 320 and a hex cutout 321 disposed at the bottom end thereof. The hex cutout 321 may be configured to receive a portion of one of the driver bits 410 therein, when the storage tube 300 and the lid 500 are used as a driver, or a portion of one of the pin punches 332, 333 therein, when the storage tube 300 and the lid 500 are used as a striking tool. As shown, the storage tube 300 may include a magnet insert 322 disposed within the hex cutout 321 and configured to removably retain one of the driver bits 410 or one of the pin punches 332, 333 therein for use.

The bit holder 400 may be defined as an elongate, strip-like member having a top end and a bottom end disposed opposite one another along a vertical, longitudinal axis of the bit holder 400, with a plurality of openings defined in a lateral wall of the bit holder 400. Each of the openings may be configured for removably receiving a portion of one of the driver bits 410. In some examples, the openings may be configured for providing an interference-fit connection with the driver bits 410 for securely retaining the driver bits 410 therein. In some examples, the bit holder 400 may include a plurality of magnetic inserts disposed within the respective openings, or the bit holder 410 may be formed of a magnetic material, for securely retaining the driver bits 410 therein. In some examples, the driver bits 410 may be standard interchangeable ¼″ screwdriver bits, although other types of tool bits may be provided in other examples.

In some examples, as shown, the lid 500 may be defined as an elongate, plate-like member, having a pair of ends disposed opposite one another along a horizontal, longitudinal axis of the lid 500, a top side and a bottom side disposed opposite one another, and a pair of lateral sides extending along the longitudinal axis of the lid 500. The lid 500 may define a central cavity 510 extending therethrough from the top side to the bottom side of the lid 500. The central cavity 510 may be configured for allowing the storage tube 300 to pass therethrough and nest into the second cavity 230 of the base 200. As shown, the lid 500 may include a pair of squared-off cutouts 511, 512 that are configured for engaging the flat notches 312 of the storage tube 300 to help prevent unwanted rotation between the lid 500 and the storage tube 300 and allow the nut 600 to secure the entire assembly. When secured in place with the nut 600 to the storage tube 300, the lid 500 may function as a handle grip for the assembly, with the first tabs 531, 532 functioning as finger grooves.

The nut 600 may be formed as generally-cylindrical member having a top end and a bottom end disposed opposite one another along a vertical, longitudinal axis of the nut 600. As shown, the nut 600 may include a top portion 610 having a larger diameter and a bottom portion having a smaller diameter and including the threads 620. As noted above, the threads 620 of the nut 600 may engage the threads 311 of the storage tube 300 for securing the lid 500 to the storage tube 300. As shown in FIG. 4, when completely assembled, the top portion 610 of the nut 600 may function as an extraction tab for removing the combined assembly of the lid 500 and the storage tube 300. In some examples, the nut 600 may be made out of metal and may function as a striking tool to be used in conjunction with the pin punch 331 or the pin punch 332.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Additionally, features of various system and methods described herein that are implemented “by” or “based on” performing a step are to be construed or may be synonymous to “by at least” or “based at least in part on” performing said step rather than “by solely” or “based solely on” performing said step, unless it is explicitly stated or clear from the context. For example, a system that implements specific features “by” performing a particular step may be described in a manner that is not exclusive of the performance of other steps, some of which may be related to said particular step. In some cases, other steps may be omitted from various discussions for the sake of clarity.

That which is claimed is:

1. A tool storage box comprising:
a base defining a first cavity disposed along an internal surface of the base and a second cavity disposed along an external surface of the base;
one or more metal tool parts removably disposed within the first cavity; and
a magnetized plate disposed within the second cavity and configured for releasably retaining the one or more metal tool parts along the external surface of the base when the one or more metal tool parts are placed thereon.

2. The tool storage box of claim 1, wherein the one or more metal tool parts comprises one or more driver bits.

3. The tool storage box of claim 1, wherein the one or more metal tool parts comprises one or more pin punches.

4. The tool storage box of claim 1, further comprising a lid removably coupled to the base and covering an open end of the base.

5. The tool storage box of claim 4, wherein the lid is removably coupled to the base by a plurality of tabs and a plurality of cutouts having an interference fit.

6. The tool storage box of claim 4, further comprising:
a storage tube coupled to the lid and defining an internal cavity; and
one or more tool parts disposed within the internal cavity of the storage tube.

7. The tool storage box of claim 6, wherein the storage tube is removably coupled to the lid by a nut.

8. The tool storage box of claim 7, wherein the storage tube is configured for use as a driver when coupled to the lid by the nut, and wherein the lid is configured for use as a handle when coupled to the storage tube by the nut.

9. The storage tool box of claim 6, wherein the one or more tool parts comprises one or more one or more pin punches.

10. The storage tool box of claim 6, wherein the base further defines a third cavity disposed along the internal surface of the base and configured for removably receiving the storage tube therein when the lid is coupled to the base.

11. A tool storage box comprising:
a base defining a first cavity disposed along an internal surface of the base;
a lid removably coupled to the base and covering an open end of the base;
a storage tube coupled to the lid and defining an internal cavity, wherein the storage tube is removably disposed within the first cavity when the lid is coupled to the base; and
one or more tool parts disposed within the internal cavity of the storage tube.

12. The tool storage box of claim 11, wherein the storage tube is removably coupled to the lid by a nut.

13. The tool storage box of claim 12, wherein the storage tube is configured for use as a driver when coupled to the lid by the nut, and wherein the lid is configured for use as a handle when coupled to the storage tube by the nut.

14. The storage tool box of claim 11, wherein the one or more tool parts comprises one or more one or more pin punches.

15. The storage tool box of claim 11, wherein the lid is removably coupled to the base by a plurality of tabs and a plurality of cutouts having an interference fit.

16. The storage tool box of claim 11, wherein the base further defines a second cavity disposed along the internal surface of the base and configured for receiving one or more additional tool parts.

17. The storage tool box of claim 16, wherein the one or more additional tool parts comprises one or more driver bits.

18. The storage tool box of claim 17, wherein the one or more driver bits comprises a plurality of driver bits coupled to a bit holder.

19. The storage tool box of claim 11, wherein the base further defines a third cavity disposed along an external surface of the base and retaining a magnetized plate therein, and wherein the magnetized plate is configured for releasably retaining one or more metal tool parts along the external surface of the base when the one or more metal tool parts are placed thereon.

20. A tool storage box comprising:
a base defining a first cavity disposed along an internal surface of the base, a second cavity disposed along the internal surface of the base, and a third cavity disposed along an external surface of the base;
a lid removably coupled to the base and covering an open end of the base;
a storage tube coupled to the lid and defining an internal cavity, wherein the storage tube is removably disposed within the first cavity when the lid is coupled to the base;
one or more tool parts disposed within the internal cavity of the storage tube;
one or more metal tool parts removably disposed within the second cavity; and
a magnetized plate disposed within the third cavity and configured for releasably retaining the one or more metal tool parts along the external surface of the base when the one or more metal tool parts are placed thereon.
